(19) United States
(12) Patent Application Publication
(10) Pub. No.: US 2021/0302852 A1
(43) Pub. Date: Sep. 30, 2021

(54) TONER PARTICLE

(71) Applicant: Hewlett-Packard Development Company, L.P., Spring, TX (US)

(72) Inventors: Keiichi Ishikawa, Yokohama (JP); Takahiro Danno, Yokohama (JP); Osamu Ieda, Yokohama (JP)

(21) Appl. No.: 17/050,954

(22) PCT Filed: May 23, 2019
(86) PCT No.: PCT/US2019/033784

§ 371 Date: Oct. 27, 2020

(30) Foreign Application Priority Data
Jul. 20, 2018 (JP) 2018-136716

(51) Int. Cl. G03G 9/087; G03G 9/08; C08G 63/20; C08G 63/672

(52) U.S. Cl. CPC G03G 9/08755; G03G 9/08795; C08G 63/672; C08G 63/20; G03G 9/08797; G03G 9/0819

(57) ABSTRACT

A binder resin for toner includes an amorphous polyester resin and a crystalline polyester resin. The amorphous polyester resin has a weight average molecular weight of 5,000 to 30,000, inclusively, and contains 1 mol % to 10 mol %, inclusively, of a constituent unit having a pendant group with 3 to 32, inclusively, carbon atoms. The crystalline polyester resin has a weight average molecular weight of 5,000 to 15,000, inclusively. The binder resin has an endothermic amount Tg2nd-dH of 5 J/g to 50 J/g, inclusively.

### BACKGROUND

Methods for visualizing image information via an electrostatic charge image, such as an electrophotographic method, have been used in various fields.

In an electrophotographic method, a surface of a photoreceptor is uniformly charged, and then an electrostatic charge image is formed on the surface of the photoreceptor; and an electrostatic latent image is developed by a developer containing toner particles and visualized as a toner image. This toner image is transferred and fixed onto a surface of a recording medium to form an image. The following may be used as a developer: a two-component developer comprising a toner particle and a carrier; and a one-component developer using a magnetic toner or a non-magnetic toner alone.

A toner may comprise a toner particle containing an amorphous polyester resin, a crystalline polyester resin, wax, and a colorant, wherein the crystalline polyester resin has a weight average molecular weight (Mw) of 5,000 or more and 14,000 or less, and the crystalline polyester resin contains 0.5 mass % or more and 15.0 mass % or less of a segment derived from one or more aliphatic compounds selected from the group consisting of aliphatic monocarboxylic acids with a carbon number of 8 or more and 20 or less and aliphatic monohydric alcohols with a carbon number of 8 or more and 20 or less.

An emulsion aggregation toner may comprises a core including at least one amorphous resin, at least one crystalline resin, and may further comprise one or more ingredients selected from the group consisting of colorants, waxes, and combinations thereof; and a shell comprising a branched amorphous resin of a predetermined chemical formula.

A toner for developing an electrostatic charge image, may include a binder resin wherein the binder resin contains: an amorphous polyester resin having alkenyl groups, wherein 5% or more of the alkenyl groups has a branched structure; and a crystalline polyester resin, wherein an ester group concentration (M) is from 0.07 or more to 0.10 or less and represented by the following equation:

ester concentration (M)=K/A. Equation:

where, K represents the number of ester groups in the crystalline polyester resin and A represents the number of atoms that form a polymer chain of the crystalline polyester resin.

A toner for developing an electrostatic charge image having at least binder resin, may comprise three or more elements selected by including at least an iron element, a silicon element, and a sulfur element from the group consisting of an iron element, a silicon element, and a sulfur element and a fluorine element, wherein: a content of iron element, a content of silicon element, a content of sulfur element and a content of fluorine element are in respective predetermined ranges; the binder resin contains at least an amorphous polyester-based resin; and the amorphous polyester-based resin: (1) has an aromatic ring concentration of 4.5 to 5.8 mol/kg; (2) has a weight average molecular weight (Mw) of 7,000 to 50,000; (3) has a glass transition temperature (Tg) of 50 to 70° C., and (4) satisfies the Equation 1 (below) when the weight average molecular weight (Mw) thereof is 7,000 or more and less than 14,000,

Tg=7.26×ln(Mw)+a (where −19.33≤a≤−4.29) (Equation 1)

and satisfies the Equation 2 (below) when the weight average molecular weight (Mw) thereof is 14,000 or more and 50,000 or less,

Tg=2.67×ln(Mw)+b (where 21.07≤b≤39.48) (Equation 2).

An amorphous polyester resin may be obtained by reaction between:

a polyester resin (A) obtained by reaction between a polyhydric alcohol component and a first polycarboxylic acid component, wherein at least one of them includes a 3 or higher hydric polyhydric alcohol component and/or a 3 or higher carboxylic poly-carboxylic acid component, and having a weight average molecular weight of 6,000 to 40,000 and a hydroxyl value of 15 to 70 mgKOH/g; and

a second polycarboxylic acid component (a) under conditions satisfying the equations (1), (2) and (3) (below),

wherein the amorphous polyester resin satisfies the equation (4) (below); and

a binder resin for toner containing this amorphous polyester resin.

(AV_{B}−AV_{A})/AVₐ=0.5 to 0.7 (1)

Mw_{B}/Mw_{A}=1.1 to 2.0 (2)

OHV_{B}/AV_{B}=1.0 to 6.0 (3)

Mw_{B}/Mn_{B}=3.0 to 15.0 (4)

In the equations, AV_{B}, OHV_{B}, Mw_{B} and Mn_{B} represent an acid value, a hydroxyl value, a weight average molecular weight and a number average molecular weight, respectively, of the amorphous polyester resin; AV_{A} and Mw_{A} represent an acid value and a weight average molecular weight, respectively, of the polyester resin (A); and Ave represents a theoretical acid value of the second polycarboxylic acid (a).

In order to reduce power consumption from the viewpoint of the energy conservation, toner images may be fixed at lower temperatures. For fixing at lower temperatures, for example, measures are taken to reduce a glass transition temperature or a molecular weight of a binder resin of a toner particle.

When the glass transition temperature or a molecular weight of the binder resin of the toner particle is lowered, there is a tendency by which: toner is aggregated inside a printer or during transportation, thereby deteriorating the preservability; or a stress received during printing causes deterioration of images of continuous printing due to insufficient durability of toner particles.

An example toner particle includes a binder resin, a colorant and a wax. The toner particle includes, as the binder resin, an amorphous polyester resin having a weight average molecular weight within a range having a minimum of 5,000 and a maximum of 30,000 and containing 1 mol % to 10 mol % of a constituent unit having a pendant group with 3 to 32 carbon atoms, and a crystalline polyester resin having a weight average molecular weight of 5,000 to 15,000. The binder resin has an endothermic amount Tg2nd-dH of 5 J/g to 50 J/g.

An example binder resin for toner includes an amorphous polyester resin and a crystalline polyester resin. The amorphous polyester resin has a weight average molecular weight between 5,000 and 30,000, inclusive, and contains between 1 mol % and 10 mol %, inclusive, of a constituent unit having a pendant group with 3 to 32 carbon atoms. The crystalline polyester resin has a weight average molecular weight between 5,000 and 15,000, inclusive. The binder resin has an endothermic amount Tg2nd-dH between 5 J/g and 50 J/g, inclusive.

An example method for producing a binder resin for toner includes mixing an amorphous polyester resin having a weight average molecular weight between 5,000 and 30,000, inclusive, and containing between 1 mol % and 10 mol %, inclusive of a constituent unit having a pendant group with 3 to 32 carbon atoms, and a crystalline polyester resin having a weight average molecular weight between 5,000 and 15,000, inclusive. The amorphous polyester resin is mixed with the crystalline polyester resin so that the binder resin has an endothermic amount Tg2nd-dH between 5 J/g and 50 J/g, inclusive.

### BRIEF DESCRIPTION OF DRAWINGS

FIG. 1 is a TEM photograph showing an example of a binder resin usable for an example toner particle.

FIG. 2 is a TEM photograph showing another binder resin.

### DETAILED DESCRIPTION

In the following description, with reference to the drawings, the same reference numbers are assigned to the same components or to similar components having the same function, and overlapping description is omitted.

An example toner particle may include a binder resin. The example binder resin may include an amorphous polyester resin having a weight average molecular weight between 5,000 and 30,000, inclusive and containing between 1 mol % and 10 mol %, inclusive, of a constituent unit having a pendant group between 3 and 32 carbon atoms. Hereinafter, this predetermined amorphous polyester resin may be referred to as a pendant-type amorphous polyester resin. Further, the amorphous polyester resin referred to hereinafter may include both of this pendant-type amorphous polyester resin and/or other amorphous polyester resins.

The amorphous polyester resin may be a polyester that does not have an endothermic peak measured by, for example, differential scanning calorimetry (DSC). An amorphous polyester may be defined as a polyester that exhibits stepwise endotherm changes when the measurement is conducted at a temperature rise rate of 10° C./min by, for example, differential scanning calorimetry; or as a polyester that has a half width of endothermic peak above 15° C.

The amorphous polyester resin may have a glass transition temperature (Tg) of 50 to 80° C., in some examples, or of 50 to 70° C. in some examples.

The amorphous polyester resin may be produced by reacting a polycarboxylic acid of the aliphatic series, alicyclic series or aromatic series, or an alkylester thereof with a polyhydric alcohol through direct esterification reaction or transesterification reaction.

The polyester may be produced, for example, at a polymerization temperature of 180 to 230° C.; and if necessary, the pressure in a reaction system is reduced and the reaction is caused while water or alcohol generated during condensation is removed. When a polymeric monomer is not dissolved or compatible at a reaction temperature, a solvent having a high boiling point may be added as a solubilizing agent for dissolution. During polycondensation reaction, the solubilizing agent is removed by distillation. When a polymeric monomer with unfavorable compatibility is present in copolymerization reaction, the unfavorably compatible polymeric monomer may be condensed in advance with an acid or an alcohol that is to be polycondensed with the polymeric monomer, and then, may be polycondensed with the main component.

Examples of a catalyst usable for the production of polyester include alkali metal compounds of sodium, lithium or the like, alkali earth metal compound of magnesium, calcium or the like, metal compounds of zinc, antimony, titanium, tin, zirconium, germanium or the like, phosphate compounds, phosphate compounds, and amine compounds.

Examples of polycarboxylic acids used for obtaining the amorphous polyester resin include phthalic acid, isophthalic acid, terephthalic acid, tetrachlorophthalic acid, chlorophthalic acid, nitrophthalic acid, p-carboxyphenylacetic acid, p-phenylenediacetic acid, m-phenylenediglycollic acid, p-phenylenediglycollic acid, o-phenylenediglycollic acid, diphenylacetic acid, diphenyl-p,p′-dicarboxylic acid, naphthalene-1,4-dicarboxylic acid, naphthalene-1,5-dicarboxylic acid, naphthalene-2,6-dicarboyxlic acid, anthracene dicarboxylic acid and/or cyclohexanedicarboxylic acid. Further, examples of usable polycarboxylic acids other than dicarboxylic acids include trimellitic acid, pyromellitic acid, naphthalene tricarboxylic acid, naphthalene tetracarboxylic acid, pyrene tricarboxylic acid, and pyrene tetracarboxylic acid. Further, those derived from a carboxylic acid group of the above carboxylic acids by an acid anhydride, an acid chloride or an ester may be used. Among these, terephthalic acid or lower esters thereof, and cyclohexanedicarboxylic acid may be used, for example. The lower esters include, for example, an ester of aliphatic alcohol with 1 to 8 carbon atoms.

The pendant-type amorphous polyester resin may be obtained by using, as a constituent monomer, for example, a polycarboxylic acid having a branched chain with 3 to 32 carbon atoms. Examples of the polycarboxylic acid include a succinic acid having an alkyl group with 3 to 32 carbon atoms, a succinic acid having an alkenyl group with 3 to 32 carbon atoms, an alkyl bissuccinic acid having an alkyl group with 3 to 32 carbon atoms, an alkenyl bissuccinic acid having an alkenyl group with 3 to 32 carbon atoms, and anhydrides thereof. For example, the polycarboxylic acid may include octylsuccinic acid, decylsuccinic acid, dodecylsuccinic acid, tetradecylsuccinic acid, hexadecylsuccinic acid, octadecylsuccinic acid, isooctadecylsuccinic acid, hexenylsuccinic acid, octenylsuccinic acid, decenylsuccinic acid, dodecenylsuccinic acid, tetrapropenylsuccinic acid, tetradecenylsuccinic acid, hexadecenylsuccinic acid, isooctadecenylsuccinic acid, octadecenylsuccinic acid, and nonenylsuccinic acid. The branched chain has a minimum carbon number of 6, in some examples, or of 24, in some examples; and a maximum carbon number of 12 in some examples, or of 18, in some examples.

Examples of the polyhydric alcohol used for obtaining the amorphous polyester resin include: aliphatic diols such as ethylene glycol, diethylene glycol, triethylene glycol, propylene glycol, butanediol, hexanediol, neopentylglycol and glycerin; alicyclic diols such as cyclohexane diol, cyclohexane dimethanol and hydrogenated bisphenol A; and aromatic diols such as an ethylene oxide adduct of bisphenol A, and a propylene adduct of bisphenol A, and one or two or more of these polyhydric alcohols may be used. Of these polyhydric alcohols, aromatic diols and alicyclic diols may be used. In some examples, aromatic diols may be used. Further, to improve a fixing property, a polyhydric alcohol with trivalence or higher (glycerin, trimethylolpropane and pentaerythritol) may be used in combination with a diol to form a crosslinking structure or a branching structure.

The amorphous polyester resin may be produced by causing condensation reaction between a polyhydric alcohol and a polycarboxylic acid. The amorphous polyester resin may be produced, for example, by mixing a polyhydric alcohol and a polycarboxylic acid, if necessary, a catalyst, in a reactor equipped with a thermometer, a stirrer and a flow-down condenser, heating at 150 to 250° C. under the presence of an inert gas (such as nitrogen gas), continuously removing by-product low-molecular compounds from a reaction system, terminating the reaction at the time when a predetermined acid value is obtained, performing cooling, and obtaining a product of interest.

Examples of the catalyst used for the synthesis of the amorphous polyester resin include catalysts of antimony, tin, titanium and aluminum. Further examples thereof include organic metals such as dibutyl tin, dilaurate and dibutyl tin oxide, and esterification catalysts such as metal alkoxides, for example, tetrabutyl titanate. Among these, for improved impact and/or safety on the environment, a tin (II) compound having no Sn—C bond may include a tin (II) compound having a Sn—O bond, a tin (II) compound having a Sn—X (X represents a halogen atom) and/or the like. Further, two or more of esterification catalyst may be mixed for use. The esterification catalyst may be present in an amount of 0.05 to 1 parts by mass, in some examples, or 0.2 to 0.7 parts by mass, in some examples, relative to a total of 100 parts by mass of an alcohol component and a carboxylic acid component.

From the viewpoint of the binder resin dispersion, the pendant-type amorphous polyester resin may have a weight average molecular weight within a range having a minimum of 5,000, in some examples, of 6,000 in some examples, or of 8,000 in yet some examples, and having a maximum of 30,000, in some examples, of 25,000, in some examples, of 18,000, in some examples, or of 16,000, in some examples. Except for the pendant-type amorphous polyester resin, an amorphous polyester resin may have a weight average molecular weight in the above range. The weight average molecular weight of the amorphous polyester resin may be obtained by molecular weight measurement, for example, a gel permeation chromatography (GPC) method of tetrahydrofuran (THF) soluble matters. For example, the following method may be carried out to obtain the weight average molecular weight of the amorphous polyester resin. Waters e2695 (made by Japan Waters Co., Ltd.) is used as a measuring device, and Inertsil CN-3 25 cm two series (made by GL Sciences Inc.) is used as a column. 10 mg of the amorphous polyester resin is introduced into 10 mL of tetrahydrofuran (THF) (containing a stabilizer, made by Wako Pure Chemical Industries, Ltd.); the mixture is stirred for 1 hour and then, filtered through a 0.2 μm filter; and the resultant filtrate is used as a sample. 20 μL of tetrahydrofuran (THF) sample solution is injected into a measurement device, and is measured at a temperature of 40° C. and at a flow rate of 1.0 mL/min.

From the viewpoint of dispersion of the crystalline polyester in the amorphous polyester resin, the pendant-type amorphous polyester resin may contain a constituent unit having a pendant group with 3 to 32 carbon atoms in an amount within a range having a minimum of 1 mol % in some examples, of 1.5 mol % in some examples, or of 2 mol % in some examples, and having a maximum of 10 mol % in some examples, of 9 mol % in some examples, or of 8 mol % in some examples, in the entire constituent units. The unit “mol %” used herein may be defined as mol % of a monomer forming a constituent unit having a pendant group in the entire constituent monomers of the pendant-type amorphous polyester resin.

The pendant-type amorphous polyester resin may include, for example, an amorphous polyester resin having 1 mol % to 10 mol % of a constituent unit as a pendant group of a hydrocarbon radical with 3 to 32 carbon atoms in the entire constituent unit. The hydrocarbon radical may be one or more group selected from alkyl groups with 3 to 32 carbon atoms and alkenyl groups with 3 to 32 carbon atoms.

From the viewpoint of the low-temperature fixing property, the pendant-type amorphous polyester resin may have a melting viscosity at 120° C. within a range having a minimum of 200 Pa·s in some examples, of 400 Pa·sin some examples, or 900 Pa·s in some examples, and having a maximum of 20,000 Pa·s in some examples, of 19,500 Pa·s in some examples, or 19,000 Pa·s, in some examples. The melting viscosity used herein may be measured by the following method, for example. By using a flow tester (Shimadzu Corporation, “CFT-500D”), 1 g of sample is shaped into a pellet at 20 Mpa, 10 kg of load is applied at a constant temperature of 120° C. by a plunger, and extruded from a nozzle with a diameter of 1 mm and a length of 1 mm. A viscosity is calculated based on the amount of falling of the plunger of the flow tester relative to the time.

Examples of amorphous polyester resins other than a pendant-type amorphous polyester resin include an amorphous polyester resin having a weight average molecular weight of over 30,000, an amorphous polyester resin containing a constituent unit having a pendant group with 3 to 32 carbon atoms in an amount of over 10 mol %, and an amorphous polyester resin containing a constituent unit having a pendant group with 3 to 32 carbon atoms in an amount of less than 1 mol %. Examples of amorphous polyester resins other than a pendant-type amorphous polyester resin include an amorphous polyester resin having a weight average molecular weight of 30,000 to 80,000. The amorphous polyester resin may have a crosslinking structure in a molecular structure, for example a crosslinking structure by a multifunctional carboxylic acid or a hydroxyl group. The constituent unit of the amorphous polyester resin may be selected from those exemplified as the pendant-type amorphous polyester resin.

The binder resin of the toner particle may contain a crystalline polyester resin having a weight average molecular weight of 5,000 to 15,000. A crystalline polyester resin referred to herein may include the above predetermined crystalline polyester resin.

A crystalline polyester may be a polyester having a clear endothermic peak measured by, for example, modulated differential scanning calorimetry (MDSC). The crystalline polyester may be used to improve the image glossiness of toner and the low-temperature fixing property.

The melting temperature (Tm) of the crystalline polyester may be, in some examples, 60 to 100° C., or in some examples 60 to 75° C. The melting point of the crystalline polyester within the range of 60 to 100° C. may prevent aggregation of toner powder, and improve the preservability of a fixed image and the low-temperature fixing property.

From the viewpoint of the crystal amount, the crystalline polyester resin may have a weight average molecular weight within a range having a minimum of 5,000 in some examples, of 5,100 in some examples, or of 5,400 in some examples, and a maximum of 15,000 in some examples, of 10,000 in some examples, of 8,000 in some examples, of 5,900 in some examples, or of 5,700 in some examples. The weight average molecular weight of the crystalline polyester resin may be obtained by molecular weight measurement, for example, a gel permeation chromatography (GPC) method of tetrahydrofuran (THF) soluble matters. The weight average molecular weight of the crystalline polyester resin may be obtained by a similar method as for the weight average molecular weight of the amorphous polyester resin.

Further, from the viewpoint of the crystal amount, the crystalline polyester resin may have a Tg2nd-dH, which expresses an endothermic amount at the time of the second temperature rise, of 25 J/g or more in some examples, or of 40 J/g or more in some examples. The Tg2nd-dH mentioned herein may be an endothermic amount of the resin, which is measured a second time by a modulated differential scanning calorimeter (MDSC). The Tg2nd-dH may be obtained by the following method, for example. A sample resin is subjected to first and second temperature rise processes using a modulated differential scanning calorimeter Q2000 (manufactured by TA Instruments). In the first temperature rise process, the temperature is increased from room temperature to 140° C. at a rate of 3° C./min with a modulated amplitude of 0.1° C. and a modulated period of 10 seconds, and after the completion, is decreased to 0° C. at a rate of 20° C./min. The temperature is maintained at 0° C. for 5 minutes. Thereafter, in the second temperature rise process, the temperature is increased again from 0° C. to 140° C. at a rate of 3° C./min with a modulated amplitude of 0.1° C. and a modulated period of 10 seconds. A differential scanning calorimetry curve thus obtained is used to provide a dH.

The above-described range of weight average molecular weight or Tg2nd-dH of the crystalline polyester resin may improve the low-temperature fixing property, prevent the resin strength from being deteriorated and increase the strength of an image fixed on paper, as well as to prevent a glass transition temperature of toner particles from being decreased, and thus, improve the preservability regarding blocking of toner particles.

The crystalline polyester may be produced by reacting, for example, a polycarboxylic acid of the aliphatic series, alicyclic series or aromatic series, or an alkyl ester thereof with a polyhydric alcohol through direct esterification reaction or transesterification reaction in a similar manner as for the amorphous polyester resin. Regarding the temperature and the catalyst, those used in the production of the amorphous polyester resin can be employed. The crystalline polyester may be obtained by reacting, in some examples, an aliphatic polycarboxylic acid having 8 carbon atoms (except carbon atoms of a carboxylic group), in some examples, an aliphatic polycarboxylic acid having 8 to 12 carbon atoms, or in some examples, an aliphatic polycarboxylic acid having 9 or 10 carbon atoms with in some examples, a polyhydric alcohol having 8 or more carbon atoms, in some examples, a polyhydric alcohol having 8 to 12 carbon atoms, and in some examples, a polyhydric alcohol having 9 or 10 carbon atoms. The crystalline polyester may be a polyester obtained by reacting, for example, 1,9-nonanediol with 1,10-decane dicarboxylic acid or 1,9-nonanediol with 1,12-dodecane dicarboxylic acid. Control of the carbon number within this range is likely to provide a crystalline polyester having an improved melting temperature for toner particles. Also, use of the aliphatic series is likely to increase the linearity of a resin structure and to have affinity with an amorphous polyester resin.

The binder resin of the toner particle may have a Tg2nd-dH of 5 J/g to 50 J/g. The Tg2nd-dH may be within a range having a minimum of 10 J/g in some examples, of 14 J/g in some examples, of 15 J/g in yet some examples, and having a maximum of 40 J/g in some examples, of 25 J/g in some examples, of 19 J/g in some examples, or of 18 J/gin some examples. The Tg2nd-dH of the binder resin may be understood as, for example, an index expressing the compatibility between a pendant-type amorphous polyester resin and a crystalline polyester resin. The Tg2nd-dH of the binder resin may be defined in a similar manner as described above.

The toner particle may have a mass ratio between a pendant-type amorphous polyester resin and a crystalline polyester resin, expressed as a pendant-type amorphous polyester resin/a crystalline polyester resin, of 75/25 in some examples, of 80/20 in some examples; of 95/5 in some examples, or of 90/10 in some examples.

In addition to a polyester resin, the binder resin may contain, for example, styrene-(meth)acryl copolymers, epoxy resin, and styrene-butadiene copolymers. Among these, styrene-(meth)acryl copolymers may be used when colored particles are produced directly by a chemical method such as an emulsion aggregation method or a suspension polymerization method. Examples of monomers for producing a styrene-acryl copolymer include: styrene-based monomers such as o-(m-, p-)methyl styrene, and m-(p-)ethyl styrene; (meth)acrylate-based monomers such as methyl(meth)acrylate, ethyl(meth)acrylate, propyl(meth)acrylate, butyl(meth)acrylate, octyl(meth)acrylate, dodecyl(meth)acrylate, stearyl(meth)acrylate, behenyl(meth)acrylate, 2-ethylhexyl(meth)acrylate, dimethylaminoethyl(meth)acrylate, and diethylaminoethyl (meth) acrylate; and ene-type monomers such as butadiene, isoprene, cyclohexene, (meth)acrylonitrile and amide acrylates.

Further, a crosslinking agent may be used during the production of the binder resin. Among crosslinking agents used during the production of the binder resin, examples of bifunctional crosslinking agent include divinyl benzene, bis(4-acryloxy polyethoxyphenyl)propane, ethylene glycol diacrylate, 1,3-butylene glycol diacrylate, 1,4-butanediol diacrylate, 1,5-pentandiol diacrylate, 1,6-hexanediol diacrylate, neopentylglycol diacrylate, diethyleneglycol diacrylate, triethyleneglycol diacrylate, tetraethyleneglycol diacrylate, diacrylates of polyethylene glycol #200, #400 and #600, dipropyleneglycol diacrylate, polypropyleneglycol diacrylate, polyester-type diacrylate, and those prepared by substituting dimethacrylate for the above-described diacrylate.

Examples of the crosslinking agent include pentaerythritol triacrylate, trimethylol ethane triacrylate, trimethylol propane triacrylate, tetramethylol methane tetraacrylate, oligoesteracrylate and a methacrylate thereof, 2,2-bis (4-methacryloxy, polyethoxyphenyl) propane, diallyl phthalate, triallyl cyanurate, triallyl isocyanurate, and triallyl trimellitate.

The crosslinking agents may be used in an amount of 0.01 to 10 parts by mass in some examples, or of 0.1 to 5 parts by mass relative to 100 parts by mass in some examples, of the polymeric monomer forming the binder resin.

A ratio of the amorphous polyester resin in the binder resin may be within a range having a minimum of 70 mass % in some examples, or of 80 mass % in some examples; and a maximum of 92 mass % in some examples, or 90 mass % in some examples. A ratio of the pendant-type amorphous polyester resin in the binder resin may be within a range having a minimum of 55 mass % in some examples, or of 70 mass % in some examples; and a maximum of 90 mass % in some examples, of 85 mass % in some examples, or of 80 mass % in some examples. A ratio of the crystalline polyester resin in the binder resin may be within a range having a minimum of 8 mass % in some examples, or of 10 mass % in some examples; and a maximum of 30 mass % in some examples, or of 20 mass % in some examples. A ratio of the pendant-type amorphous polyester resin in the amorphous polyester resin may be within a range having a minimum of 90 mass %, or of 95 mass % in some examples; and a maximum of 100 mass % in some examples, or of 98 mass % in some examples. A ratio of the total of the pendant-type amorphous polyester resin and the crystalline polyester resin in the binder resin may be within a range having a minimum of 80 mass % in some examples, of 85 mass % in some examples, and a maximum of 90 mass % in some examples; of 98 mass % in some examples, or of 95 mass % in some examples.

The toner particle may contain the amorphous polyester resin in an amount within a range having a minimum of 48 mass % in some examples, or of 56 mass % in some examples; and a maximum of 72 mass % in some examples, or of 64 mass % in some examples. The toner particle may contain the pendant-type amorphous polyester resin in an amount within a range having a minimum of 48 mass % in some examples, or of 56 mass % in some examples; and a maximum of 72 mass % in some examples, or of 64 mass % in some examples. The toner particle may contain the crystalline polyester resin in an amount within a range having a minimum of 10 mass % in some examples, or of 15 mass % in some examples; and a maximum of 30 mass % in some examples, or of 20 mass % in some examples. The toner particle may contain the binder resin in an amount within a range having a minimum of 40 mass % in some examples, of 45 mass % in some examples, or of 50 mass % in some examples; and a maximum of 90 mass % in some examples, of 85 mass % in some examples, or of 75 mass % in some examples.

The toner particle may contain a colorant. As the colorant, a colorant selected from, for example, a black colorant, a cyan colorant, a magenta colorant and a yellow colorant may be contained. The black colorant may be carbon black or aniline black. The yellow colorant may be a condensed nitrogen compound, an isoindolinone compound, an anthraquinone compound, an azo metal complex, and an allyl imide compound. Specifically, examples thereof include C.I. Pigment Yellow 12, 13, 14, 17, 62, 74, 83, 93, 94, 95, 109, 110, 111, 128, 129, 147, 168 and 180.

The magenta colorant may be a condensed nitrogen compound, an anthraquinone compound, a quinacridone compound, a base dye lake compound, a naphthol compound, a benzo imidazole compound, a thioindigo compound, a perylene compound. Examples thereof include C.I. Pigment Red 2, 3, 5, 6, 7, 23, 48:2, 48:3, 48:4, 57:1, 81:1, 122, 144, 146, 166, 169, 177, 184, 185, 202, 206, 220, 221 and 254. The cyan colorant may be a copper phthalocyanine compound and a derivative thereof, and an anthraquinone compound. Examples thereof include C.I. Pigment Blue 1, 7, 15, 15:1, 15:2, 15:3, 15:4, 60, 62 and 66. These colorants may be used, for example, alone or as a mixture of two or more kinds thereof, and selection may be carried out considering the hue, the chroma, the brightness, the weather resistance, the dispersibility in toner and others.

A content of the colorant is not particularly limited as long as it is sufficient to color toner particles; but it may be within a range having a minimum of 0.5 parts by mass in some examples, of 1 parts by mass in some examples, or of 2 parts by mass in some examples; and a maximum of 15 parts by mass in some examples, of 12 parts by mass in some examples, or of 10 parts by mass in some examples, based on 100 parts by mass of toner particles. When the content of the colorant is 0.5 parts by mass or more based on 100 parts by mass of toner particles, a sufficient coloring effect is produced; and when it is 15 parts by mass or less, this is likely to provide a sufficient triboelectric charging amount without causing a large impact on an increase of production cost of toner particles.

The toner particle may include a wax. The wax can function as a release agent. The release agent improves the low-temperature property, the final image durability and the wear resistance characteristic of the toner particle, so the kind and content of the wax working as the release agent may be determined in consideration of the characteristics of the toner. The wax may be a natural wax or a synthetic wax. The kind of wax may be selected from, but limited thereto, the group consisting of polyethylene-based waxes, polypropylene waxes, silicon wax, paraffin-based waxes, ester-based waxes, carnauba wax, beeswax, and metallocene wax. More specifically, examples thereof include solid paraffin wax, micro wax, rice wax, fatty acid amide-based wax, fatty acid-based wax, aliphatic mono ketones, fatty acid metal salt-based wax, fatty acid ester-based wax, partially saponified fatty acid ester-based wax, silicon varnish, higher alcohols, carnauba wax and the like. In addition, polyolefins such as low molecular weight polyethylene and polyproylene may be used. The wax may have a melting temperature within a range of 60 to 100° C. in some examples, or within a range of 70 to 90° C. in some examples. Components of the wax may be physically adhered to toner particles, but may not form a covalent bond with the toner particles.

The content of the wax may be 1 part by mass or more in some examples, 2 parts by mass in some examples, or 3 parts by mass in some examples, based on 100 parts by mass of toner particles. The content of the wax may be 20 parts by mass in some examples, 16 parts by mass in some examples, or 12 parts by mass in some examples, based on 100 parts by mass of toner particles. The content of the wax may be within a range having a minimum of 1 part by mass in some examples, of 2 parts by mass in some examples, or of 3 parts by mass in some examples, and a maximum of 20 parts by mass in some examples, of 16 parts by mass in some examples, or of 12 parts by mass in some examples, based on 100 parts by mass of toner particles. There is a tendency by which: when the content of the wax is 1 part by mass or more, the low-temperature fixing property and a fixing temperature range may be improved; and when it is 20 parts by mass or less, the preservability and the economic efficiency can be improved.

Further, the wax may be an ester-based wax including an ester group. Examples thereof include a mixture of an ester-based wax and a non-ester-based wax, and an ester group-containing wax wherein an ester group is contained in a non-ester-based wax. Since an ester group has high affinity with a latex component of the toner particle, an ester-based wax component enables the wax to be present uniformly in toner particles and allows the function of the wax to be effectively exhibited. A non-ester-based wax component has a function to be released from latex, and thereby, it is likely to suppress excessive plasticization that may occur when wax is formed exclusively of an ester-based wax. As a result, a mixture of an ester-based wax and a non-ester-based wax tends to maintain improved developability of toner for a long period.

Examples of ester-based wax may include esters of a mono- to pentavalent alcohol with a fatty acid having 15 to 30 carbon atoms such as behenyl behenate, stearyl stearate, stearate of pentaerythritol, and glyceryl montanate. An alcohol component constituting an ester may be a monovalent alcohol with 10 to 30 carbon atoms or a polyhydric alcohol with 3 to 30 carbon atoms. Examples of non-ester-based wax include a polyethylene-based wax, a polypropylene-based wax, a silicone wax and a paraffin-based wax. Examples of the ester group-containing wax include a mixture of a paraffin-based wax and an ester-based wax, and an ester group-containing paraffin-based wax. Examples thereof include product names P-212, P-280, P-318, P-319 and P-419 of Chukyo Yushi Co., Ltd.

When the wax is a mixture of a paraffin-based wax and an ester-based wax, a content of the ester-based wax may be within a range having a minimum of 1 mass % or more in some examples, of 5 mass % in some examples, of 10 mass % in some examples, or of 15 mass % in some examples; and a maximum of 50 mass % in some examples, based on the entire weight of the mixture of a paraffin-based wax and an ester-based wax. When the content of the ester-based wax is 1 mass % or more, the compatibility with latex that is used during the production of toner particles may be better maintained. When it is 50 mass % or less, this is likely to allow toner particles to have an improved plasticity and to improve a long-term maintenance of developability.

The wax may be selected so that a solubility parameter (SP) value of the binder resin has a difference of 2 or more from a SP value of the paraffin-based wax and a SP value of the ester-based wax. When the SP value difference is small, a plasticization phenomenon may occur between the binder resin and the wax.

The toner particle may contain a charge control agent, if necessary. The charge control agent may be a metal compound of aromatic carboxylic acid, which can achieve a high speed of triboelectric charging of toner and maintain a constant amount of triboelectric charge stably. Examples of a negative charge control agent include: salicylic acid metal compounds; naphthoic acid metal compounds; dicarboxylic acid metal compounds; polymer-type compounds having sulfonic acid or carboxylic acid in a side chain; polymer-type compounds having a sulfonic acid salt or an esterified sulfonic acid in a side chain; polymer-type compounds having a carboxylic acid salt or an esterified carboxylic acid in a side chain; boron compounds; urea compounds; silicon compounds; and calixarenes. Examples of a positive charge control agent include: quaternary ammonium salts; polymer-type compounds having the above-described quaternary ammonium salt in a side chain; guanidine compounds; and imidazole compounds. The charge control agent may be added to the toner particles internally, or be added externally.

The toner particles may contain inorganic fine particles if necessary. The inorganic fine particles may be internally added to the toner particles or may be added as an external additive. When they are contained as an external additive, they may be such inorganic fine particles as silica fine particles, titanium oxide fine particles, and aluminum oxide fine particles. The inorganic fine particles may be hydrophobized with a hydrophobizing agent such as a silane compound, a silicone oil or a mixture thereof. When the inorganic fine particles are used for improvement of the fluidity of toner, a specific surface area thereof may be within a range having a minimum of 50 m²/g and a maximum of 400 m²/g. Meanwhile, when the inorganic fine particles are used for improvement of the durability of toner, a specific surface area thereof may be 10 m²/g to 50 m²/g. In order to ensure the compatibility between the fluidity improvement and the durability improvement, inorganic fine particles having a specific surface area in the above range may be used in combination. When the inorganic fine particles are contained as an external additive, a ratio thereof may be within a range having a minimum of 0.1 parts by mass and a maximum of 10.0 parts by mass, relative to 100 parts by mass of the toner particles. Mixing of toner particles with inorganic fine particles can be carried out using a mixer such as a Henschel mixer.

The toner particle may have, for example, a sea-island structure including a matrix portion of the pendant-type amorphous polyester resin and a domain of the wax. For example, the domain portion may have a longitudinal diameter within a range having a minimum of 0.3 μm and a maximum of 1.5 μm. For example, at least a part of the domain portion may be a two-layer domain portion wherein the periphery is coated with a compatible layer of the crystalline polyester resin and the pendant-type amorphous polyester resin. When the longitudinal diameter of the domain portion is within the above range, particles sizes become appropriate thereby providing an improved anti-offset property and an improved durability. Further, a ratio of the two-layer domain portion in the domain portion may be within a range having a minimum of 10 mass % and a maximum of 50 mass %. This range provides a moderate compatibility between the pendant-type amorphous polyester resin and the crystalline polyester resin, thereby providing an improved low-temperature fixing property.

The toner particle may have a structure wherein the crystalline polyester resin is dispersed in the amorphous polyester resin. Dispersed particles of the crystalline polyester resin in the amorphous polyester resin may have an average particle diameter within a range having a minimum of 5 nm in some examples, or of 10 nm in some examples; and a maximum of 500 nm in some examples, or of 250 nm in some examples. The average particle diameter can be calculated from, for example, a TEM (transmission electron microscope) image. In addition, the average particle diameter may be measured in a state where the amorphous polyester resin and the crystalline polyester resin are mixed with each other before the production of toner particles.

The binder resin of the toner particle may have a peak value of a relation d log G′/dt between a temperature t and a storage elastic modulus G′ of the crystalline polyester resin of 0.7 or more. In addition, a ratio (tan δ) of storage elastic modulus relative to a loss elastic modulus at the temperature at the time of the peak of d log G′/dt of the crystalline polyester resin may be 1.0 or less. The peak value of d log G′/dt used herein may be measured by the following method, for example. As a measurement device, a rotational plate rheometer “ARES” (manufactured by TA Instruments) is used. As a measurement sample, used is 0.25 g of a sample, which is molded by pressure at 20 MPa for 1 minute by means of a tablet molding machine. In the behavior of change of the storage elastic modulus G′ when the temperature is increased from 40° C. to 100° C. under the conditions of a rate of temperature rise of 2° C./min, a frequency of 10 Hz and a strain control mode (strain: 0.01% to 3%), the amount of change (d log G′/dt) of logarithm log G′ of the storage elastic modulus with respect to temperature is calculated in 1° C. intervals, and a maximum value is regarded as a peak value of d log G′/dt. The storage elastic modulus with respect to the loss elastic modulus at a temperature when d log G′/dt is a maximum value is regarded as tan δ. Toner containing the crystalline polyester resin having a peak value of d log G′/dt of 0.7 or more can cause a sharp elastic change by thermal energy during fixing. In addition, toner containing the crystalline polyester resin having tan δ at a temperature at the peak of 1.0 or less does not cause imbalanced behavior of change in the elastic component and the viscous component, and it has an improved low-temperature fixing property.

Regarding the toner particle, a relation d log G′/dt between a temperature t and a storage elastic modulus G′ of the toner particle may have a peak value during temperature rising which is 1.5 times or more than a peak value during temperature lowering. Further, the temperature at the peak of d log G′/dt during temperature rising may be 8° C. or more higher than the temperature at the peak of d log G′/dt during temperature lowering. The toner particles satisfying this relation exhibits heat characteristic by which a softening during temperature rise is sharp and a curing during temperature drop is slow. This can provide an improved fixing property to paper even under severe conditions such as speeding-up or quick starting. The peak values of d log G′/dt during temperature rising and temperature lowering may be measured by the following method, for example. As a measurement device, a rotational plate rheometer “ARES” (manufactured by TA Instruments) is used. A sample of 0.25 g is used as a measurement sample, which is molded by pressure at 20 MPa for 1 minute by means of a tablet molding machine. In the behavior of change of the storage elastic modulus G′ when the temperature is increased from 40° C. to 100° C. under the conditions of a rate of temperature rising of 2° C./min, a frequency of 10 Hz and a strain control mode (strain: 0.01% to 3%), the amount of change (d log G′/dt) of logarithm log G′ of the storage elastic modulus with respect to temperature is calculated in 1° C. intervals, and a maximum value is regarded as a peak value of d log G′/dt during temperature rising. In the behavior of change of the storage elastic modulus G′ when the temperature is decreased from 100° C. to 40° C. under the conditions of a rate of temperature rising of 2° C./min, a frequency of 10 Hz and a strain control mode (strain: 0.01% to 3%), the amount of change (d log G′/dt) of logarithm log G′ of the storage elastic modulus with respect to temperature is calculated in 1° C. intervals, and a maximum value is regarded as a peak value of d log G′/dt during temperature lowering. Toner at a fixing nip portion receives heat from a high-temperature fixing member, and at the same time, loses heat due to the impact from low-temperature paper and pressure member. Thus, when rapid softening and rapid curing occur simultaneously, the toner is cured with unsuitable properties for fixing to paper, thereby causing poor fixing (peeling of an image caused by tape peeling or the like). Therefore, it is necessary to increase the temperature due to poor fixing even without occurrence of cold offset, and consequently, the effect of low-temperature fixing is diminished. Under the conditions such as speeding-up or quick starting where paper or a pressure member have a lower temperature, this phenomenon may become noticeable. The toner particles satisfying the above relation exhibit heat characteristic that softening during temperature rise is sharp while curing during temperature drop is slow. This may improve a fixing property to paper even under severe conditions such as speeding-up or quick starting.

The toner particle may contain three or more elements selected by including at least an iron element, a silicon element, and a sulfur element from the group consisting of an iron element, a silicon element, a sulfur element and a fluorine element. The content of the iron element may be 1.0×10³ to 1.0×10⁴ ppm; the content of the silicon element may be 1.0×10³ to 5.0×10³ ppm; and the content of the sulfur element may be 500 to 3,000 ppm. When a fluorine element is contained, the content of the fluorine element may be 1.0×10³ to 1.0×10⁴ ppm. The iron element and the silicon element may be components derived from a flocculant or the like; the sulfur element may be a component derived from a catalyst for the production of a binder resin, a flocculant or the like; and the fluorine element may be a component derived from a catalyst for the production of a binder resin, or the like. Because of this, the contents of the iron element and the silicon element in the toner particle can be controlled by adjusting the kind and the amount of a flocculant to be used; the content of the sulfur element can be controlled by adjusting the kinds and the amounts of a catalyst and a flocculant to be used; and the content of the fluorine element can be controlled by adjusting the kind and the amount of a catalyst to be used. The content of the iron element in the toner particle may be, as described above, 1.0×10³ to 1.0×10⁴ ppm in some examples, or 1,000 to 5,000 ppm in some examples. When the content of the iron element is 1.0×10³ to 1.0×10⁴ ppm, the toner particle has improved properties to be used as toner for developing electrostatic charge images. The content of the silicon element in the toner particle may be, as described above, 1.0×10³ to 5.0×10³ ppm in some examples, or 1,500 to 4,000 ppm in some examples. When the content of the silicon element is 1.0×10³ to 5.0×10³ ppm, the toner particle may have improved properties to be used as toner for developing electrostatic charge images. The content of the sulfur element in the toner particle may be, as described above, 500 to 3,000 ppm in some examples, or 1,000 to 3,000 ppm in some examples. When the content of the sulfur element is 500 to 3,000 ppm, the toner particle may have improved properties to be used as toner for developing electrostatic charge images. When the toner particle contains the fluorine element, the content of the fluorine element in the toner particle may be, as described above, 1.0×10³ to 1.0×10⁴ ppm in some examples, or 5,000 to 8,000 ppm in some examples. When the content of the fluorine element is 1.0×10³ to 1.0×10⁴ ppm, the toner particle may have improved properties to be used as toner for developing electrostatic charge images. The content of each element in the toner particle can be measured by, for example, a fluorescent X-ray analysis method. A fluorescent X-ray analyzer EDX-720 (manufactured by SHIMADZU Co., Ltd.) may be used as a measurement device, and measurement can be carried out under the conditions of an X-ray tube voltage of 50 kV and a sample formation amount of 30.0 g. The content of each element can be obtained by using the intensity of a quantitative result derived by a fluorescent X-ray measurement (cps/μA).

The toner particle may be produced by any of a pulverizing method and a polymerization method. To allow it to have a predetermined a sea-island structure as described above, the toner particle may be produced by a polymerization method, for example. A method for producing an example toner particle containing, as binder resins, a pendant-type amorphous polyester resin and a crystalline polyester resin, by a polymerization method will be described, according to an example. A polycarboxylic acid, which includes a polycarboxylic acid having a branched chain, a polyhydric alcohol, an esterification catalyst and the like are fed into a reactor; an esterification reaction was caused in accordance with the reaction conditions of a method; and a pendant-type amorphous polyester resin is obtained. The obtained pendant-type amorphous polyester resin is dissolved in a suitable solvent such as methyl ethyl ketone or isopropyl alcohol, and pH adjustment, addition of water and removal of the solvent are carried out, so that a dispersion with a predetermined concentration of pendant-type amorphous polyester resin, or a latex is obtained. In the meantime, regarding a crystalline polyester resin, a dispersion or a latex thereof is prepared through an esterification reaction in a similar manner as for the pendant-type crystalline polyester resin. Further, in accordance with the conditions of a polymerization method, a colorant dispersion and a wax dispersion are each prepared. For example, for the preparation of a wax dispersion, firstly, a wax, an anionic surfactant and water are input into a reactor. A content of a release agent in the mixture of the wax, the anionic surfactant and the water is appropriately determined considering the dispersion state. Examples of the anionic surfactant include an alkyl benzene sulfonate salt. A content of the anionic surfactant in the mixture of the wax, the anionic surfactant and the water is appropriately determined considering the dispersion state. A content of the water in the mixture of the release agent, the anionic surfactant and the water is appropriately determined considering the dispersion state, the preservability and the economic efficiency. In a process for forming a release agent dispersion, thereafter, the mixture of the release agent, the anionic surfactant and the water is subjected to dispersion treatment, so that the release agent dispersion is obtained. As a method for dispersing the mixture, a method using a homogenizer may be used. Further, as each of the colorant dispersion and the wax dispersion, a commercially available product may be used. First, the latex of the pendant-type amorphous polyester resin and the latex of the crystalline polyester resin are mixed in, for example, an aqueous system; then, the colorant dispersion and the wax dispersion are mixed; and a flocculant is added. The mixture is stirred by a homogenizer or the like, and heated, so that aggregated particles containing a binder resin including the pendant-type amorphous polyester and the crystalline polyester resin, a colorant and a wax are obtained. The binder resin mentioned herein may have an endothermic amount Tg2nd-dH of 5 J/g to 50 J/g. Next, the latex of the pendant-type amorphous polyester resin is further mixed to form a coating layer composed of the pendant-type amorphous polyester resin on the surface of the aggregated particles, so that coated aggregated particles are obtained. Further, the coated aggregated particles are heated to melt and unite particles in the coated aggregated particles, so that toner particles are obtained. This method provides so-called core-shell type toner particles.

An example method for producing a toner particle includes:

mixing together the following:
a dispersion containing an amorphous polyester resin having a weight average molecular weight of 5,000 to 30,000 and containing 1 mol % to 10 mol % of a constituent unit having a pendant type with 3 to 32 carbon atoms, and water;
a dispersion containing a crystalline polyester resin having a weight average molecular weight of 5,000 to 15,000, and water;
a dispersion containing a colorant and water; and
a dispersion containing a wax and water with one another,

producing aggregated particles containing a binder resin including the amorphous polyester resin and the crystalline polyester resin, and the colorant and the wax, wherein the binder resin has an endothermic amount Tg2nd-dH of 5 J/g to 50 J/g,

mixing another dispersion of the amorphous polyester resin with the aggregated particles to form a coating layer comprising the amorphous polyester resin on the surface of the aggregated particles.

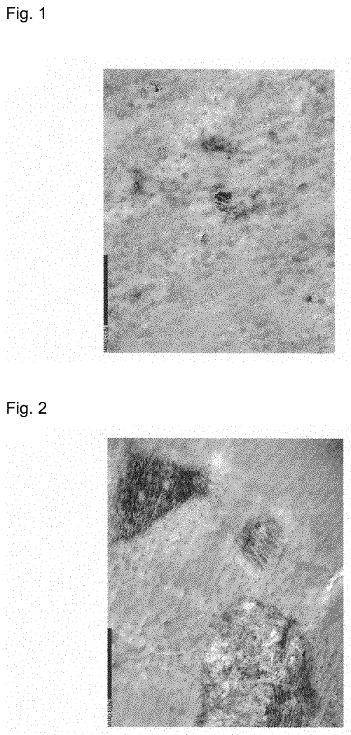

The toner particle may contain, as the binder resin, the above-described predetermined pendant-type amorphous polyester resin and the above-described predetermined crystalline polyester resin. Mixing both of them with each other provides a state where, in a matrix of the pendant-type amorphous polyester resin, crystalline polyester resin visually recognized as a black particle is minutely dispersed, as shown in FIG. 1. FIG. 1 shows an example of the binder resin for toner. Meanwhile, when another amorphous polyester resin is used, crystalline polyester resin visually recognized as a black particle can be coarse and the dispersion thereof may be poor as shown in FIG. 2. In FIGS. 1 and 2, a scale indicating 500.0 nm is indicated as a black line at a lower left side. The toner particle may have an average particle diameter within a range having a minimum of 4 μm in some examples, or of 5 μm in some examples, and a maximum of 7 μm in some examples, or 6 μm in some examples. The average particle diameter used herein may be a volume average particle diameter obtained by, for example, the following method.

Volume Average Particle Diameter of Toner Particle

The volume average particle diameter of toner particles is measured by a pore electrical resistance method. Coulter Counter (manufactured by Beckman Coulter, Inc.) may be used as a measurement device, ISOTON II (manufactured by Beckman Coulter, Inc.) may be used as an electrolyte solution, and an aperture tube with an aperture diameter of 100 μm may be used, and measurement is carried out under the condition of a measurement particle number of 30,000. Based on the measured particle size distribution of particles, volumes occupied by particles included in divided particle size ranges may be accumulated from a smaller diameter side to a larger diameter side, and a particle diameter, which provides a cumulative volume of 50%, may be regarded as a volume average particle diameter Dv50.

A toner may contain the example toner particles disclosed herein and the other components disclosed herein. The toner containing the toner particles disclosed herein may be used as a one-component developer. In order to improve the dot reproducibility and to supply stable images over a long period, the toner may be mixed with a magnetic carrier and used as a two-component developer. Examples of the magnetic carrier usable herein include: iron oxide; metal particles of, for example, iron, lithium, calcium, magnesium, nickel, copper, zinc, cobalt, manganese, chromium and rare-earths, alloy particles and oxide particles thereof; magnetic substances such as ferrite; and magnetic substance-dispersed resin carrier (so-called resin carriers) containing a magnetic substance, and a binder resin holding the magnetic substance in a dispersed state. When the example toner is mixed with a magnetic carrier and used as a two-component developer, a mixing ratio of the magnetic carrier and the toner is set so that the concentration of the toner in the two-component developer may be 2 mass % to 15 mass % in some examples, and further may be 4 mass % to 13 mass % in some examples.

An example binder resin for toner, may include an amorphous polyester resin (pendant-type amorphous polyester resin) having a weight average molecular weight of 5,000 to 30,000 and containing 1 mol % to 10 mol % of a constituent unit having a pendant group with 3 to 32 carbon atoms, and a crystalline polyester resin having a weight average molecular weight of 5,000 to 15,000, wherein an endothermic amount Tg2n-dH is 5 J/g to 50 J/g. The matters mentioned on the example toner particles may be applicable to the example binder resins for the examples of toner disclosed herein. Examples of the amorphous polyester resin and the crystalline polyester resin may be similar to those of the examples of toner particle disclosed herein. The binder resin for toner may have a structure wherein the crystalline polyester resin is dispersed in the amorphous polyester resin. The binder resin for toner may have a structure wherein the crystalline polyester resin is dispersed in the amorphous polyester resin and a dispersed particle of the crystalline polyester resin in the amorphous polyester resin has an average particle diameter of 10 nm to 500 nm. The amorphous polyester resin may have a melting viscosity at 120° C. of 200 Pa·s to 20,000 Pa·s. A mass ratio between the amorphous polyester resin and the crystalline polyester resin, amorphous polyester resin/crystalline polyester resin, is 75/15 to 95/5. The amorphous polyester resin may contain, as a constituent monomer, a polycarboxylic acid having a branched chain with 3 to 32 carbon atoms. The amorphous polyester resin may contain, as a constituent monomer, one or more compounds selected from a succinic acid having an alkyl group with 3 to 32 carbon atoms, a succinic acid having an alkenyl group with 3 to 32 carbon atoms, an alkyl bissuccinic acid having an alkyl group with 3 to 32 carbon atoms, an alkenyl bissuccinic acid having an alkenyl group with 3 to 32 carbon atoms, and anhydrides thereof. A ratio of the amorphous polyester resin (pendant-type amorphous polyester resin) may be 70 mass % to 90 mass %. A ratio of the crystalline polyester resin may be 8 mass % to 30 mass %. The Tg2nd-dH of the crystalline polyester resin may be 25 J/g or more. The crystalline polyester resin may contain, as a constituent monomer, one or more compounds selected from aliphatic polycarboxylic acids having 8 to 12 carbon atoms and one or more compounds selected from polyhydric alcohols having 8 to 12 carbon atoms.

An example method for producing a binder resin for toner, which includes mixing: an amorphous polyester resin having a weight average molecular weight of 5,000 to 30,000 and containing 1 mol % to 10 mol % of a constituent unit having a pendant group with 3 to 32 carbon atoms with a crystalline polyester resin having a weight average molecular weight of 5,000 to 15,000, wherein the amorphous polyester resin and the crystalline polyester resin are mixed with each other so that the binder resin has an endothermic amount Tg2nd-dH of 5 J/g to 50 J/g. The matters mentioned herein on the examples of toner particle and the examples of binder resin for toner may be applicable to the method for producing a binder resin for toner. Examples of the amorphous polyester resin and the crystalline polyester resin may be similar to those of the toner particle according to examples disclosed herein.

Various examples of the binder resin and of the toner particle will be described.

### Examples 1-1 to 1-3 and Comparative Examples 1-1 to 1-3

### Synthesis Example 1-1

Glycols and acids, and an esterification catalyst were fed in respective amounts shown in Table 1 into a 5-liter four-necked flask equipped with anitrogen introducing tube, a dehydrating tube, a stirrer and a thermocouple, and reacted with each other at 230° C. under a nitrogen atmosphere until 90% of reaction rate. Thereafter, the reaction was continued at 8.3 kPa until a suitable softening point was achieved, so that an amorphous polyester resin 1 of Table 1 was obtained. Amorphous polyester resins 2 and 4 of Table 1 were produced in a similar manner as described above except that the kind and the feeding amount of glycol and acid were changed as shown in Table 1.

### Synthesis Example 1-2

Glycols and acids, and an esterification catalyst were fed in respective amounts shown in Table 1 into a 5-liter four-necked flask equipped with a nitrogen introducing tube, a dehydrating tube, a stirrer and a thermocouple, and reacted with each other at 230° C. under a nitrogen atmosphere until 90% of reaction rate. Then, the reaction temperature was decreased to 210° C., trimellitic anhydride was added, and the reaction was continued at normal pressure for 1 hour. Thereafter, the reaction was continued at 8.3 kPa until a suitable softening point was achieved, so that an amorphous polyester resin 3 of Table 1 was obtained. An amorphous polyester resin 5 of Table 1 was produced in a similar manner as described above except that the kind and the feeding amount of glycol and acid were changed as shown in Table 1.

### Synthesis Example 2

133 g of 1,9-nonanediol (manufactured by Wako Pure Chemical Industries, Ltd.), 167 g of dodecanedioic acid (manufactured by Wako Pure Chemical Industries, Ltd.), and esterification catalyst were fed into a 500-mL separable flask. Thereafter, nitrogen was introduced into the flask, a mixture of 1,9-nonanediol and esterification catalyst was heated to 80° C. and dissolved while being stirred in the flask by a stirrer. Then, the mixture solution in the flask was heated to 97° C. while being stirred in the flask. Then, the flask was evacuated (to 10 mPa·s or less), a dehydro-condensation reaction between 1,9-nonanediol and dodecanedioic acid was caused at 97° C. for 5 hours while stirring the mixture in the flask, so that a crystalline polyester resin 1 was obtained. The crystalline polyester resin 1 had a weight average molecular weight of 5600, and further, had a Tg2nd-dH of 149 J/g. For the crystalline polyester resin, the melting point (endothermic peak temperature) measured by a differential scanning calorimeter was 70.1° C.; the difference between an endothermic start temperature at the time of temperature rise and an endothermic peak temperature in a differential scanning calorimetry curve was 4.3° C.; and the endothermic amount at the time of melting was 3.4 W/g. Further, the acid value was 9.20 mgKOH/g and the sulfur content was 186.62 ppm. The feeding amount and the others of the crystalline polyester resin 1 are shown in Table 2.

### Latex Production Example 1

300 g of amorphous polyester resin 1, 250 g of methyl ethyl ketone and 50 g of isopropyl alcohol were fed into a 3-liter double jacket reactor and stirred under an environment at about 30° C. using a semi-moon type impeller in the reactor to dissolve the resin. While the obtained resin solution was stirred, 20 g of 5% aqueous ammonia solution was gradually fed into the reactor, and subsequently, 1200 g of water was added fed at a rate of 20 g/min, so that an emulsified liquid was produced. Thereafter, a mixture solvent of methyl ethyl ketone and isopropyl alcohol was removed from the emulsified liquid by a reduced-pressure distillation method until the concentration of the amorphous polyester resin 1 as a solid content was 20 mass %, and thereby a resin latex was obtained. This was used as amorphous polyester resin latex 1. Latexes containing amorphous polyester resins 2 to 5 were obtained in a similar manner except that an amorphous polyester resin was changed. These were used as amorphous polyester resin latexes 2 to 5. Table 3 shows emulsified particle diameters of amorphous polyester resin latexes 1 to 5.

### Latex Production Example 2

300 g of crystalline polyester resin 1, 250 g of methyl ethyl ketone and 50 g of isopropyl alcohol were fed into a 3-litter double jacket reactor and stirred under an environment at about 30° C. using a semi-moon type impeller in the reactor to dissolve the resin. While the obtained resin solution was stirred, 25 g of 5% aqueous ammonia solution was gradually fed into the reactor, and subsequently, 1200 g of water was added fed at a rate of 20 g/min, so that an emulsified liquid was produced. Thereafter, a mixture solvent of methyl ethyl ketone and isopropyl alcohol was removed from the emulsified liquid by a reduced-pressure distillation method until the concentration of the crystalline polyester resin 1 as a solid content was 20 mass %, and thereby a resin latex was obtained. This was used as crystalline polyester resin latex 1. Table 3 shows an emulsified particle diameter of the crystalline polyester resin latex 1.

Evaluation of Binder (Binding) Resin

Each of the amorphous polyester resin latexes 1 to 5 was fed into a 100-ml polycup so that a resin content thereof became 0.8 g. Next, the crystalline polyester resin latex 1 was fed so that a resin content thereof became 0.2 g. A freeze-dryer was used for −40° C./1.5 hr, −10° C./2 hr and 20° C./5 hr, to conduct vacuum and dehydration, so that mixture samples were obtained. Table 4 shows compositions and physical properties of the samples.

TABLE 1

| | | | Amorphous polyester resin | | | | |
|---|---|---|---|---|---|---|---|
| | | | 1 | 2 | 3 | 4 | 5 |
| Feeding | Glycol | BPA-2PO | 49 | 49 | 51 | 49 | 47 |
| amount | | BPA-2EO | 3 | 3 | | 3 | 2 |
| (mol %) | Acid | Terephthalic acid | 41 | 45 | | 49 | 47 |
| | | Isophthalic acid | | | 47 | | |
| | | Dodecenylsuccinic | 8 | 4 | | | |
| | | acid | | | | | |
| | | Isooctadecenyl- | | | 2 | | |
| | | succinic acid | | | | | |
| | | Trimellitic | | | 1 | | 3 |
| | | anhydride | | | | | |

| Weight average molecular weight | | 10,575 | 10,658 | 13,000 | 10,685 | 56,200 |
|---|---|---|---|---|---|---|
| Melting viscosity(Pa · s)(FT/120° C.) | | 900 | 992 | 19,000 | 989 | 33,230 |
| Branched | mol % | 8 | 4 | 2 | 0 | 0 |
| chain | Carbon number | 12 | 12 | 18 | 0 | 0 |

BPA-2PO represents propylene oxide adduct of bisphenol A (average addition molar number: 2). BPA-2EO represents ethylene oxide adduct of bisphenol A (average addition molar number: 2).

TABLE 2

| | | | Crystalline |
|---|---|---|---|
| | | | polyester resin 1 |
| Feeding | Acid | 1,12-dodecanedioic acid | 53 |
| amount | Glycol | 1,9-nonanediol | 47 |
| (mol %) | | | |

| | |
|---|---|
| Weight average molecular weight | 5,600 |
| Tg2nd-dH (J/g) | 149 |

TABLE 3

| | | Average particle diameter of |
|---|---|---|
| | | emulsified particles (nm) |
| Amorphous polyester | 1 | 164 |
| resin latex | 2 | 102 |
| | 3 | 100 |
| | 4 | 124 |
| | 5 | 263 |
| Crystalline polyester | 1 | 137 |
| resin latex | | |

TABLE 4

| | | | | | | Comparative | | |
|---|---|---|---|---|---|---|---|---|
| | | | Example | | | Example | | |
| | | | 1-1 | 1-2 | 1-3 | 1-1 | 1-2 | 1-3 |
| Blending | Amorphous polyester | 1 | 80 | | | | | 90 |
| Amount | resin latex | 2 | | 80 | | | | |
| (part | | 3 | | | 80 | | | |
| by mass) | | 4 | | | | 80 | | |
| | | 5 | | | | | 80 | |
| | Crystalline polyester | 1 | 20 | 20 | 20 | 20 | 20 | 10 |
| | resin latex | | | | | | | |

| | | | | | | |
|---|---|---|---|---|---|---|
| Tg2nd-dH (J/g) of binder resin | 19.2 | 18.8 | 7.4 | 15.7 | 15.0 | 0.0 |
| Dipersed particle diameter of | 10 | 50 | 15 | 500 | 600 | — |
| crystalline polyester resin *¹ (nm) | | | | | | |

*¹ Average particle diameter of crystalline polyester resin particles dispersed in the amorphous polyester resin

### Examples 2-1 to 2-3 and Comparative Examples 2-1 to 2-3

The amorphous polyester resin latexes 1 to 5 and the crystalline polyester resin latex 1 used in Example 1-1 and others, and the following components were used to produce toner particles for the evaluation of the fixing property.

Preparation Example of Colorant Dispersion

10 g of anionic reactive emulsifier (HS-10 manufactured by DKS Co., Ltd.) and 60 g of cyan pigment (C.I. Pigment Blue 15:3 manufactured by Clariant K.K.) were fed into a milling bath. Further, 400 g of glass bead having a diameter within a range of 0.8 mm to 1 mm was also added thereto, and milling was carried out at normal temperature, so that a colorant dispersion was obtained.

Wax Dispersion

As a wax dispersion, a commercially available product (SELOSOL P-212 manufactured by Chukyo Yushi Co., Ltd.) was used.

### Latex Production Example 3

300 g of amorphous polymer polyester resin, 250 g of methyl ethyl ketone and 50 g of isopropyl alcohol were fed into a 3-litter double jacket reactor and stirred an environment at about 30° C. using a semi-moon type impeller in the reactor to dissolve the resin. While the obtained resin solution was stirred, 20 g of 5% aqueous ammonia solution was gradually fed into the reactor, and subsequently, 1200 g of water was added at a rate of 20 g/min, so that an emulsified liquid was produced. Thereafter, a mixture solvent of methyl ethyl ketone and isopropyl alcohol was removed from the emulsified liquid by a reduced-pressure distillation method until the concentration of the amorphous polymer polyester resin as a solid content was 20 mass %, and thereby a resin latex was obtained, and used as amorphous polymer polyester resin latex 1. In the above, the amorphous polymer polyester resin had constituent monomers of BPA-2PO/BPA-2E0/ethylene glycol/terephthalic acid/dodecenylsuccinic acid/trimellitic anhydride at a ratio of 31/16/4/43/2/4 (mol %), and had a weight average molecular weight of 31,000.

Preparation of Toner Particle

500 g of deionized water, 630 g of amorphous polyester resin latex 1, 70 g of amorphous polymer polyester resin latex, and 143 g of crystalline polyester resin latex were fed into a 3-L reactor; then, 60 g of a colorant dispersion, and 80 g of a wax dispersion (SELOSOL P-212 manufactured by Chukyo Yushi Co., Ltd.) were added; 70 g of polysilicate iron (PSI-100 manufactured by Suido Kiko Kaisha, Ltd.) was added as a flocculant; and the mixture solution in the reactor was heated to 45° C. at a rate of 1° C./min while being stirred using a homogenizer (Ultra Turrax T50 (tradename) manufactured by IKA Co.). Subsequently, the aggregation liquid was heated at a rate of 0.2° C./min to allow the aggregation reaction to continue, and primary aggregation particles having a volume average particle size of 4 μm to 6 μm were obtained. Further, 210 g of the amorphous polyester resin latex 1 for a shell layer and 23 g of the amorphous polymer polyester resin latex were fed into a reactor to cause aggregation for 30 minutes. Next, 0.1N NaOH aqueous solution was added to adjust the pH of the mixture solution to 9.5. After a lapse of 20 minutes, the mixture solution was heated to cause fusing for 3 to 5 hours, and thereby, secondary aggregation particles having a volume average particle size of 4 μm to 7 μm. Ice of deionized water was added to this aggregation liquid at a rate of 100 ml/10 sec to cool to 28° C. or lower. Thereafter, a filtration process was carried out, particles were separated and dried, and toner particles of Example 2-1 were obtained (ratio of temperature rise peak value/temperature drop peak value=1.52; temperature rise peak temperature−temperature drop peak temperature=8.7° C.).

Toner particles of Examples 2-2 and 2-3, and Comparative Examples 2-1 to 2-3 were obtained in a similar manner except that the kind and the feeding amount of latex were changed so as to provide the composition of a binder resin as described in Table 5. When the binder resin has a composition as shown in Table 5, Tg2nd-dH of the binder resin is almost the same as that of the binder resin of Table 4.

Fixing Property

Toner particles produced as described above were used and their fixing properties were evaluated by the following method. Results are shown in Table 5.

(1) Minimum Fixing Temperature

(1-1) Non-Fixed Image Preparation

Paper with 90 g/m² was masked with an OHP sheet having a hollow rectangle with 25 mm×40 mm, and toner particles were scraped onto the paper so that the weight of toner was 0.36 mg/cm² on the paper at an applied voltage of 1 kv over SUS316 ϕ0.04×300 mesh (aperture of 0.04 mm).

(1-2) Fixing

Fixing evaluation was conducted using an external fixing unit, which was remodeled from a fixing unit of a multifunction color laser printer (MultiXpress 7 manufactured by Samsung Electronics) (linear velocity of a heat belt: 280 mm/sec). A radiation thermometer (c 0.98) was used to monitor a heat belt surface temperature and a pressure roller surface temperature, and a paper sheet having a non-fixed image printed thereon was passed through them when the pressure roller surface temperature became −20° C. relative to the heat belt temperature.

(1-3) Fixing Strength Evaluation

The image density of the passed image was measured using a colorimeter (X-rite eXact manufactured by X-rite Inc.). A scotch (registered tradename) tape was affixed on the image; 5 to-and-from movements of a weight of 500 g were made while paper with a basis weight of 60 g/m² was placed therebetween; and the tape was detached at 180°. After the detachment of the tape, the image density was measured, and the image density after detachment relative to that before detachment was regarded as a fixing strength. The above operation was conducted at a changed temperature of the heat belt, and a temperature at which the fixing strength became 90% was regarded as a minimum fixing temperature.

(2) P-Roll Temperature Dependency

The fixing strength was additionally measured at the above minimum fixing temperature when the pressure roller surface temperature was −60° C. relative to the heat belt temperature. Then, a difference relative to the fixing strength for −20° C. was regarded as P-Roll temperature dependency.

(3) Comprehensive Evaluation of the Low-Temperature Fixing Property

Based on results of minimum fixing temperatures and P-Roll temperature dependency, the evaluation was made as follows.

Good: when the minimum fixing temperature was 110° C. or lower and the P-Roll temperature dependency was 10% or lower

Fairly Good: when the minimum fixing temperature was 110° C. or lower and the P-Roll temperature dependency was more than 10%

Poor: when the minimum fixing temperature was higher than 110° C.

TABLE 5

| | | | | | | | Comparative | | |
|---|---|---|---|---|---|---|---|---|---|
| | | | | Example | | | Example | | |
| | | | | 2-1 | 2-2 | 2-3 | 2-1 | 2-2 | 2-3 |
| Composition | Amorphous | Amorphous | 1 | 78.1 | | | | | 83.6 |
| of binder | polyester | polyester | 2 | | 78.1 | | | | |
| resin | resin | resin | 3 | | | 78.1 | | | |
| (mass %) | | | 4 | | | | 78.1 | | |
| | | | 5 | | | | | 78.1 | |

| | | | | | | |
|---|---|---|---|---|---|---|
| Amorphous polymer | 8.6 | 8.6 | 8.6 | 8.6 | 8.6 | 9.3 |
| polyester resin | | | | | | |

| | | | | | | |
|---|---|---|---|---|---|---|
| Crystalline polyester resin 1 | 13.3 | 13.3 | 13.3 | 13.3 | 13.3 | 7.1 |
| Total | 100 | 100 | 100 | 100 | 100 | 100 |

| Ratio of peak value during temp. rising/ | | 1.52 | 1.22 | 1.63 | 0.48 | 0.51 | 1.75 |
|---|---|---|---|---|---|---|---|
| peak value during temp. lowering *² | | | | | | | |
| Peak temp. during temp. rising − | | 8.7 | 6.9 | 9.1 | 8.9 | 8.5 | 4.8 |
| peak temp. during temp. lowering *³ (° C.) | | | | | | | |
| Fixing property | Minimum fixing | 104° C. | 107° C. | 109° C. | 117° C. | 115° C. | 128° C. |
| | temperature | | | | | | |
| | P-Roll temp. | 6% | 13% | 5% | 16% | 17% | 14% |
| | dependency | | | | | | |
| | Comprehensive | Good | Fairly | Good | Poor | Poor | Poor |
| | evaluation of | | good | | | | |
| | low-temperature | | | | | | |
| | fixing property | | | | | | |

*² Ratio of [peak value of dlogG′/dt during temperature rising]/[peak value of dlogG′/dt during temperature lowering] in toner particles
*³ Difference [temperature at peak value of dlogG′/dt during temperature rising] − [temperature at peak value of dlogG′/dt during temperature lowering] in toner particles

1. A toner particle comprising a binder resin, a colorant and a wax,
wherein the binder resin comprises: an amorphous polyester resin having a weight average molecular weight of 5,000 to 30,000, inclusively, and containing 1 mol % to 10 mol %, inclusively, of a constituent unit having a pendant group with 3 to 32, inclusively, carbon atoms; and a crystalline polyester resin having a weight average molecular weight of 5,000 to 15,000, inclusively,
wherein the binder resin has an endothermic amount Tg2nd-dH of 5 J/g to 50 J/g, inclusively.

2. The toner particle according to claim 1, wherein the toner particle has a structure having the crystalline polyester resin dispersed in the amorphous polyester resin.

3. The toner particle according to claim 2, wherein a dispersed particle of the crystalline polyester resin in the amorphous polyester resin has an average particle diameter of 10 nm to 500 nm, inclusively.

4. The toner particle according to claim 1, wherein a relation d log G′/dt between a temperature t and a storage elastic modulus G′ of the toner particle has a peak value during temperature rising which is larger by 1.5 times or more than a peak value during a temperature lowering.

5. The toner particle according to claim 1, wherein a relation d log G′/dt between a temperature t and a storage elastic modulus G′ of the toner particle has a peak value during temperature rising which is higher by 8° C. or more than a peak value during temperature lowering.

6. The toner particle according to claim 1, wherein the amorphous polyester resin contains, as a constituent monomer, a polycarboxylic acid having a branched chain with 3 to 32, inclusively, carbon atoms.

7. The toner particle according to claim 1, wherein a ratio of the amorphous polyester resin in the binder resin is 70 mass % to 90 mass %, inclusively.

8. The toner particle according to claim 1, wherein a ratio of the crystalline polyester resin in the binder resin is 8 mass % to 30 mass %, inclusively.

9. A binder resin for toner comprising: an amorphous polyester resin having a weight average molecular weight of 5,000 to 30,000, inclusively, and containing 1 mol % to 10 mol %, inclusively of a constituent unit having a pendant group with 3 to 32, inclusively, carbon atoms; and a crystalline polyester resin having a weight average molecular weight of 5,000 to 15,000, inclusively,
wherein the binder resin has an endothermic amount Tg2nd-dH of 5 J/g to 50 J/g, inclusively.

10. The binder resin for toner according to claim 9, wherein the binder resin has a structure having the crystalline polyester resin dispersed in the amorphous polyester resin.

11. The binder resin for toner according to claim 10, wherein a dispersed particle of the crystalline polyester resin in the amorphous polyester resin has an average particle diameter of 10 nm to 500 nm, inclusively.

12. The binder resin for toner according to claim 9, wherein the amorphous polyester resin contains, as a constituent monomer, a polycarboxylic acid having a branched chain with 3 to 32, inclusively, carbon atoms.

13. The binder resin for toner according to claim 9, wherein a ratio of the amorphous polyester resin in the binder resin is 70 mass % to 90 mass %, inclusively.

14. The binder resin for toner according to claim 9, wherein a ratio of the crystalline polyester resin in the binder resin is 8 mass % to 30 mass %, inclusively.

15. A method for producing a binder resin for toner, comprising mixing an amorphous polyester resin having a weight average molecular weight of 5,000 to 30,000, inclusively, and containing 1 mol % to 10 mol %, inclusively, of a constituent unit having a pendant group with 3 to 32, inclusively, carbon atoms with a crystalline polyester resin having a weight average molecular weight of 5,000 to 15,000, inclusively,
wherein the amorphous polyester resin and the crystalline polyester resin are mixed with each other so that the binder resin has an endothermic amount Tg2nd-dH of 5 J/g to 50 J/g, inclusively.
